(19) United States
(12) Patent Application Publication
(10) Pub. No.: US 2011/0223863 A1
(43) Pub. Date: Sep. 15, 2011

(54) COMMUNICATION SYSTEM FOR AUTOMOBILE

(75) Inventor: Stephano Violleau, Creteil Cedex (FR)

(73) Assignee: VALEO SECURITE HABITACLE, Creteil Cedex (FR)

(21) Appl. No.: 13/129,585

(22) PCT Filed: Nov. 18, 2009
(86) PCT No.: PCT/EP2009/065360

§ 371 Date: May 17, 2011

(30) Foreign Application Priority Data
Nov. 21, 2008 (FR) 0806561

(51) Int. Cl. H04B 7/00

(52) U.S. Cl. 455/41.2

(57) ABSTRACT

The invention relates to a communication system for an automobile, that comprises: a receiver (R) housed in the automobile (1), said receiver (R) having at least two reception channels (C1, C2), each channel (C1, C2) being capable of receiving a piece of information transmitted at a predetermined radio frequency (f1, f2); at least one transmitter (E1, E2) capable of transmitting at least a piece of information. According to the invention, the transmitter is capable of transmitting said information at at least one of the two frequencies (f1, f2) that can be received by said reception channels (C1, C2) of said receiver (R).

The present invention relates to a communication system for motor vehicle equipped with control and monitoring devices.

Motor vehicles are currently equipped with numerous control and monitoring devices, such as hands-free control of access and/or starting, remote control of access, or monitoring of tire pressure.

These devices generally communicate with the vehicle by radiofrequency waves, between a portable transmitter or one situated on the vehicle, and a receiver housed in the vehicle.

The use of multichannel receivers has been envisaged in order, when the transmissions of the various devices are simultaneous, to prevent the transmissions of the various transmitters from interfering and causing the non-execution of a command or of a desired instruction.

Nonetheless, with the generalization of applications using radiofrequency communication means, be they automotive or non-automotive applications, such as mobile telephony or home automation, and on account of the regulatory constraints limiting the frequency allocation spans, a device operating in proximity to a vehicle, but not specific to this vehicle, can easily give rise to interference disturbing the proper operation of the control and monitoring devices operating in respect of this vehicle.

The object of the present invention is therefore to remedy this major drawback, by proposing a communication system for motor vehicle comprising:
a receiver housed in the motor vehicle, said receiver comprising at least two reception channels, each channel being able to receive an item of information transmitted at a determined radio frequency,
a transmitter able to transmit at least one item of information, characterized in that the transmitter is able to transmit said item of information on at least two determined frequencies able to be received by said reception channels of the receiver.

Other characteristics and advantages of the invention will become apparent on reading the detailed description which follows and the figures in which:

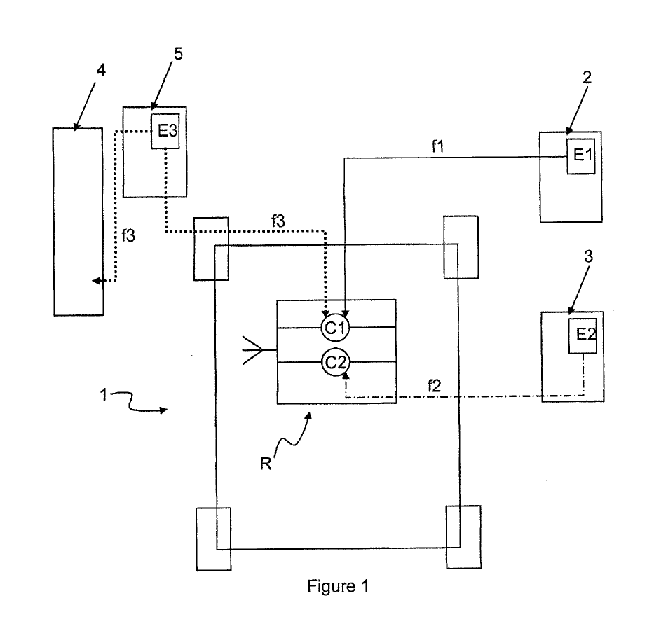

FIG. 1 illustrates a communication system according to the prior art;

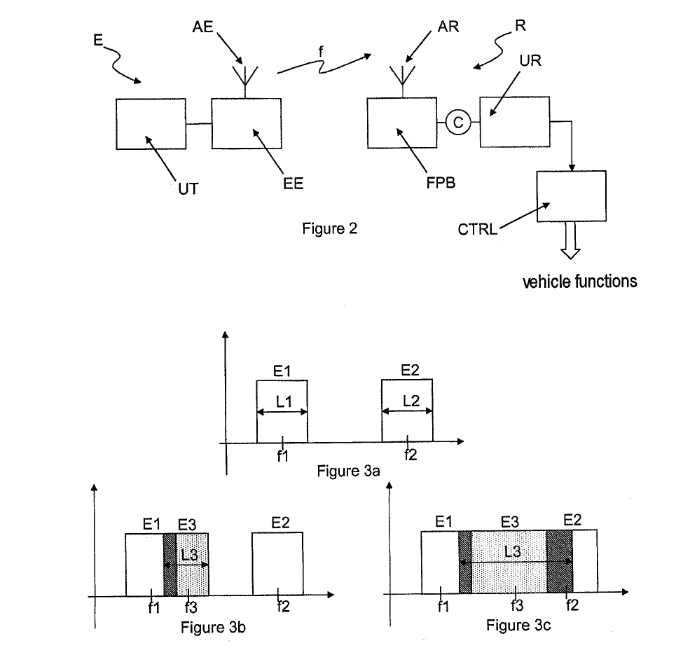

FIG. 2 shows diagrammatically the process of information exchange between a transmitter and a receiver for the execution of an action on a motor vehicle;

FIGS. 3a to 3c represent curves of frequency overlap between various transmissions for a communication system according to the prior art;

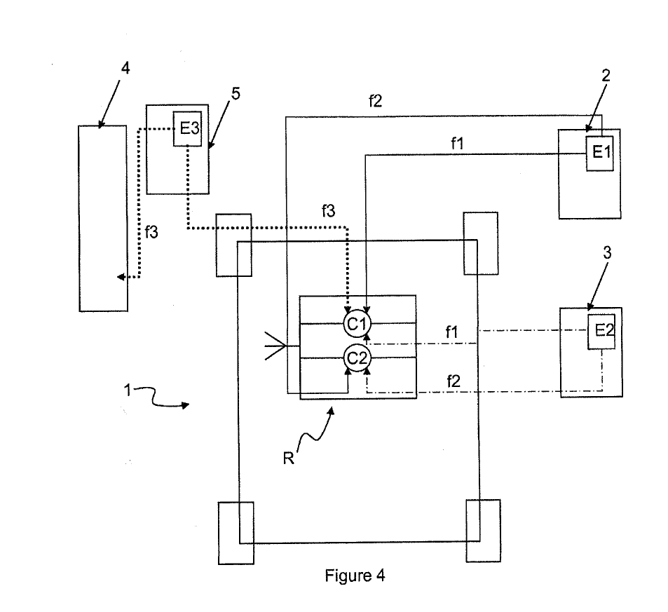

FIG. 4 illustrates a communication system according to the invention;

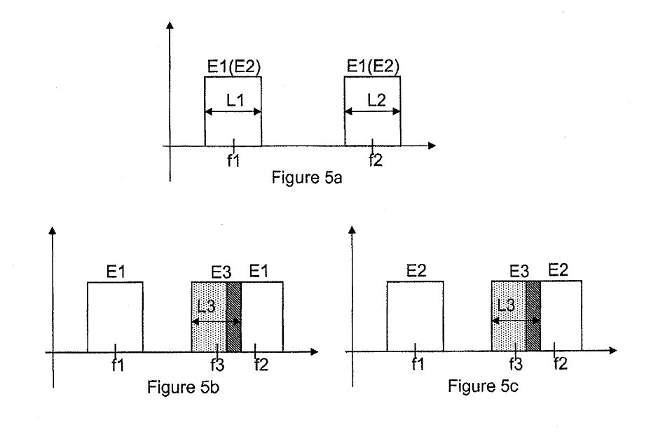

FIGS. 5a to 5c represent curves of frequency overlap between various transmissions for a communication system according to the invention.

FIG. 1 represents a communication system in accordance with the prior art in which a vehicle 1 is furnished with at least one receiver R having at least two reception channels, C1 and C2, able to receive information transmitted at frequencies f1 and f2, respectively by transmitters E1 and E2.

The principle of the exchange between a transmitter E and a receiver R is shown diagrammatically in FIG. 2. The transmitter E comprises a processing unit UT for generating the item of information to be transmitted. This processing unit UT is linked to a radiofrequency transmission stage EE which transmits, by way of a transmission antenna AE, the item of information generated by the processing unit UT at the frequency f.

The receiver R comprises for its part a reception antenna AR and a reception unit UR to which the information received by the antenna AR is transmitted by way of a bandpass filter FPB centered on the transmission frequency f, thus defining a reception channel C.

The information output from this reception unit UR is dispatched to a controller CTRL which analyses this information and controls the various functions of the vehicle associated with the information received.

In the example illustrated by FIG. 1, E1 is the transmitter of a remote control 2 for accessing the vehicle 1 and E2 is the transmitter of a hands-free badge 3 for accessing and/or starting the same vehicle 1.

The operation of an access remote control 2 and of a hands-free badge 3 as well as their mode of exchanging information with the motor vehicle 1 are elements that are well known to the person skilled in the art and will not form the subject of a detailed description outside of the elements necessary for the understanding of the present invention.

Also represented in FIG. 1, in proximity to the vehicle 1, is an automatic garage door 4, activated by a remote control 5 furnished with a transmitter E3 transmitting at the frequency f3.

For a better comprehension of the subsequent description it is specified that a transmit spectrum centered on the frequency f and of width L, and a transmit spectrum centered on the frequency f′ and of width L′, overlap at least partially if:
in the case where f<f′, we have: f′−L′/2<f +L/2;
in the case where f>f′, we have: f′+L′/2>f−L/2;
f=f′

In FIGS. 3a to 3c the transmit spectra of the various transmitters E1, E2 and E3 are schematically represented.

The transmit spectra of the transmitters E1, E2 and E3 are respectively centered on f1 and of width L1, centered on f2 and of width L2, and centered on f3 and of width L3.

More precisely, FIG. 3a presents the transmit spectra of the transmitters E1 and E2 for the information transmitted at the frequencies f1 and f2 and received by the receiver R respectively on the channels C1 and C2. In accordance with the configuration of a communication system with multichannel receivers of the prior art, the transmit spectra of the transmitters E1 and E2 have no significant frequency overlap, that is to say the channels C1 and C2 have been chosen spaced far enough apart in frequency so that, in the case of simultaneous transmission of the transmitters E1 and E2, the information transmitted by each of the transmitters is received by the receiver R on the respective channels C1 and C2 without disturbance, and that therefore each desired command can be executed.

When the remote control 5 of the garage door control device 4 is activated in proximity to the vehicle 1, a control item of information is transmitted by the transmitter E3 at the frequency f3. If the transmissions of E1 and E3 are simultaneous, if as illustrated in FIG. 3b, the respective spectra overlap at least partially, and finally if the power levels of the transmissions are of the same order of magnitude, the command transmitted by the transmitter E1 may not be executed, and the vehicle may not be locked or unlocked by the access remote-control system 2.

In the case where the transmit spectrum of E3 at the frequency f3 overlaps that of E2 at the frequency f2, that the transmissions are simultaneous, and that the power levels of the transmissions are of the same order of magnitude, the command transmitted by the transmitter E2 may not be executed, and the vehicle may not be locked or unlocked, or starting may not take place with the aid of the hands-free badge system 3.

FIG. 3c illustrates a still more critical situation for which the transmit spectrum of E3 at the frequency f3 overlaps at one and the same time that of E1 at the frequency f1 and that of E2 at the frequency f2, and where therefore, when the remote control 5 of the garage door control device 4 is activated in proximity to the vehicle, neither of the access or starting devices 2 or 3 will be able to operate correctly insofar as the power levels of the transmissions are of the same order of magnitude.

By way of illustration we have considered, for a device in accordance with the prior art, the following values:
for the access remote control 2, the transmitter E1 has an information transmit spectrum which is centered on a frequency f1 of 433.6 MHz and of width 200 kHz; the item of information is, in a known manner, a control item of information for locking or unlocking the openable panels (doors, trunk, tailgate, etc.);
for the hands-free badge 3, the transmitter E2 has an information transmit spectrum which is centered on a frequency f2 of 434.2 MHz and of width 200 kHz; the item of information is, in a known manner, a response item of information replying to a request for authentication of the vehicle;
and for the garage door 4 remote control 5, the transmitter E3 has an information transmit spectrum which is centered on a frequency f3 of 433.90 MHz and of width 500 kHz; the item of information is, in a known manner, an item of information for triggering the garage doors.

At the level of the receiver R, the channel C1 is able to receive the transmissions centered on a frequency of 433.6 MHz and of width 200 kHz and the channel C2 is able to receive the transmissions centered on a frequency of 434.2 MHz and of width 200 kHz.

These values are therefore representative of the most critical situation, that is to say in the case of simultaneous transmissions of E1, E2 and E3, the transmit spectra will overlap at least partially and the commands transmitted by 2 and 3 will not be able to be executed.

FIG. 4 now illustrates the communication system in accordance with the invention. The vehicle 1 is still furnished with a receiver R having two reception channels C1 and C2 intended to receive information transmitted respectively at frequencies f1 and f2. In contradistinction to the prior art, each of the transmitters E1 and E2 transmits at the two specific frequencies f1 and f2. Transmission by one and the same transmitter at the two frequencies may be simultaneous or sequential.

Moreover, and as illustrated in FIGS. 5a to 5c, the frequency spacing between the channel C1 and C2 is chosen in such a way that the transmissions of the transmitter E3 at the frequency f3 cannot at one and the same time overlap the transmissions of the transmitter E1 (E2) at the frequency f1 and the transmissions of the transmitter E1 (E2) at the frequency f2.

As represented in FIG. 5b, in the case of simultaneous transmissions of the transmitters E1 and E3, and when the transmissions of the transmitter E3 at the frequency f3 overlap the transmissions of the transmitter E1 at the frequency f2, the item of information transmitted by the transmitter E1 at the frequency f1 will be for its part received without disturbance by the receiver R on the channel C1. The realization of the desired command is thus obtained, transmitted by the access remote control 2.

In the same manner and as illustrated in FIG. 5c, in the case of simultaneous transmissions of the transmitters E2 and E3, the transmissions of the transmitter E3 at the frequency f3 overlap the transmissions of the transmitter E2 at the frequency f2, but the item of information transmitted by the transmitter E2 at the frequency f1 will be for its part received without disturbance by the receiver R on the channel C1. The realization of the desired command is thus obtained, transmitted by the hands-free badge 3.

By way of illustration we have considered, for a device in accordance with the invention, the following values:
for the access remote control 2, the transmitter E1 at a first transmit spectrum centered on a frequency f1 of 433.4 MHz and of width 200 kHz and a second transmit spectrum centered on a frequency f2 of 434.1 MHz and of width 200 kHz; for each of the two transmit spectra, the item of information is the same, namely a control item of information for locking/unlocking the openable panels (doors, trunk, tailgate, etc.);
for the hands-free badge 3, the transmitter E2 at a first transmit spectrum centered on a frequency f1 of 433.4 MHz and of width 200 kHz and a second transmit spectrum centered on a frequency f2 of 434.1 MHz and of width 200 kHz; for each of the two transmit spectra, the item of information is the same, namely a response item of information replying to a request from the vehicle;
and for the garage door 4 remote control 5, the transmitter E3 has a transmit spectrum centered on a frequency f3 of 433.9 MHz and of width 250 kHz.

At the level of the receiver R, the channel C1 is able to receive the transmissions centered on the frequency f1 of 433.4 MHz and of width 200 kHz and the channel C2 is able to receive the transmissions centered on the frequency f2 of 434.1 MHz and of width 200 kHz. The spacing of the channels is therefore set at 500 kHz.

These values are therefore representative of a situation in which in the case of simultaneous transmissions of E1 or E2 with E3, channel C2 will be the location of a collision between the various items of information transmitted at the frequency f2 and f3, and it will not be possible for any command to be correctly interpreted therein. Channel C1 for its part will remain available for the reception and analysis of the item of information transmitted by E1 or E2 at the frequency f1.

In another embodiment not represented but with identical values to those presented previously, the hands-free badge 3, which is also fitted with a receiver able to receive an item of information transmitted by the vehicle, when the badge is in proximity to the vehicle, will be informed, in addition to the request, regarding the fact that the channel C2 of the receiver R is currently congested. Subsequent to this request, the hands-free badge 3 will respond through a transmission at the frequency f1 able to be received by the available channel C1. This makes it possible inter alia to reduce the energy consumption of the hands-free badge. Indeed each transmission produced by the electronics of the badge consumes energy, therefore by reducing the number of transmissions to one transmission, instead of two, the energy consumption of the badge is reduced.

Moreover, it has been noted surprisingly that to obtain the expected effects through the subject of the invention, it was necessary to configure the communication system in such a way that the reception channels C1 and C2 exhibit a spacing at least equal to 300 kHz.

The examples which we have just described to illustrate our invention are not limiting. The communication system for motor vehicle can also comprise other devices furnished with radiofrequency transmitters specific to the vehicle such as for example a device for monitoring the pressure of the tires. This device is characterized in particular by the presence on each tire of a radiofrequency transmitter which transmits in particular an item of information indicative of the relative pressure of the tire.

1. A communication system for motor vehicle comprising:
a receiver housed in the motor vehicle, said receiver comprising at least two reception channels, each channel being able to receive an item of information transmitted at a determined radio frequency; and
at least one transmitter able to transmit at least one item of information, wherein the transmitter is able to transmit said item of information on at least two distinct frequencies able to be received by said reception channels of the receiver.

2. The communication system as claimed in claim 1, wherein the transmitter transmits the at least two transmission frequencies simultaneously.

3. The communication system as claimed in claim 1, wherein the transmitter transmits the at least two transmission frequencies sequentially.

4. The communication system as claimed in claim 1, wherein the transmitter is a remote control transmitter for access to the motor vehicle.

5. The communication system as claimed in claim 1, wherein the transmitter is a transmitter of tire pressure monitoring systems of the vehicle.

6. The communication system as claimed in claim 1, wherein the transmitter is a hands-free badge transmitter.

7. The communication system as claimed in claim 6, wherein the hands-free badge is furnished with a receiver able to receive a signal comprising information for telling the transmitter to transmit the item of information at a single frequency from among the at least two frequencies at which the transmitter is capable of transmitting said item of information.

8. The communication system as claimed in claim 1, wherein the frequency spacing of the two reception channels is at least equal to 300 kHz.
